(19) United States
(12) Patent Application Publication
(10) Pub. No.: US 2020/0396980 A1
(43) Pub. Date: Dec. 24, 2020

(54) Method and System for Insect Eradication in Arecaceae Trees

(71) Applicant: Al Ballaa Saleh Rasheed, Riyadh (SA)

(72) Inventor: Al Ballaa Saleh Rasheed, Riyadh (SA)

(21) Appl. No.: 16/449,578

(22) Filed: Jun. 24, 2019

(51) Int. Cl. A01M 13/00; A01G 13/04; A01G 13/10

(52) U.S. Cl. CPC A01M 13/003; A01G 13/105; A01G 13/043

(57) ABSTRACT

A method and system for eradicating insects in palm trees (such as arecaceae) by means of a lower stem encasement embedded with fumigant. Said encasement comprised of a plastic, polymer sheet with internal, flexible foam lining. The lining having a plurality of apertures configured to receive a multitude of fumigants (such as aluminum phosphide tablets) therein. The invention being wrapped around the perimeter of the aforementioned palm tree and selectively affixed by means of adhesive strips and adjustable strapping on distal ends. While it is well-known that such insects respond well to fumigants, it is difficult to make contact with them in the center of a tree. An object of the invention is to impregnate an Arecacae tree with fumigants by means of a non-invasive fumigant wrap system.

### CROSS-REFERENCE TO RELATED APPLICATIONS

This application claims the benefit of U.S. Provisional Patent Application No. 62/763,983, filed in July of 2017.

### FIELD OF THE INVENTION

The invention relates to the field of insect eradication. More specifically, it relates to a method and system for eradicating insects inside the stems of palm trees.

### BACKGROUND

Tree wraps have been used for centuries to protect young tree stems from damage associated with equipment, animals, vandalism and excess herbicide applications. Wraps are sometimes used to regulate air temperature and humidity around a stem. Early wraps were made of burlap and canvas meshes. As plastics emerged in the 1950s many agricultural researchers began wrapping stems in plastic sheeting. U.S. Pat. No. 3,333,361A granted to Manak disclosed a polypropylene wrap for tree trunks to protect bark. U.S. Pat. No. 3,816,959A granted to Nalle disclosed a plastic mesh wrap to provide trunk base structural support to young trees. U.S. Pat. No. 5,224,967A granted to Rolf disclosed a plastic wrap for trunks to mitigate bark damage. U.S. Pat. No. 9,890,536B2 granted to Lolio disclosed a plastic wrap for small trees as outer surface protection. U.S. Pat. No. 5,035,078A granted to Kipnees & Raszewski disclosed a plastic thermal wrap for trees to ward off the effects of frost. U.S. Pat. No. 6,779,311B2 granted to Roberts developed a plastic tree wrap barrier against crawling arthropods. While many tree wraps have been available to growers as a means of protecting outer bark, none were found that specifically address insect borers in Arecacea trees—commonly referred to as palm trees.

### SUMMARY OF THE INVENTION

The device herein disclosed and described provides a solution to the shortcomings in the prior art through the disclosure of a method and system for eradicating insects in arecaceae trees. An object of the invention is to protect Arecacea trees from insect borers. Borers, such as the red palm weevil Rhynchophorus ferrugineus, are one of the world's most invasive pest species because it destroys palm trees by eating them from the inside, and has currently spread to more than 60 countries in the middle east.

Another object of this invention is to allow tablet fumigant gas to reach target insects within a tree. The invention seals fumigant tablets in and around an infected stem. The fumigant gas emanating from the tablets enters the stem through minute air pockets that allow such insects to diffuse oxygen. As the insects diffuse the oxygen they are also exposed to said fumigant.

Another object of this invention is to provide a means to minimize human exposure to fumigants. Two, flexible, foam gaskets of the invention mold into dimples and crevices in the tree bark and creating seals on each end of the stem and preventing gas from escaping. The outer plastic wrap adds a second layer of protection keeping harmful gas within the trunk of the tree.

Another object of the aforementioned invention is to provide a means to secure the invention to the tree. Each end of both the foam wrap and plastic sheeting contain a strip adhesive that allow the invention to be tightly wrapped around a tree. Additional straps are cinched around the foam gaskets to ensure seal integrity.

It is briefly noted that upon a reading this disclosure, those skilled in the art will recognize various means for carrying out these intended features of the invention. As such it is to be understood that other methods, applications and systems adapted to the task may be configured to carry out these features and are therefore considered to be within the scope and intent of the present invention, and are anticipated. With respect to the above description, before explaining at least one preferred embodiment of the herein disclosed invention in detail, it is to be understood that the invention is not limited in its application to the details of construction and to the arrangement of the components in the following description or illustrated in the drawings. The invention herein described is capable of other embodiments and of being practiced and carried out in various ways which will be obvious to those skilled in the art. Also, it is to be understood that the phraseology and terminology employed herein are for the purpose of description and should not be regarded as limiting.

As such, those skilled in the art will appreciate that the conception upon which this disclosure is based may readily be utilized as a basis for designing of other structures, methods and systems for carrying out the several purposes of the present disclosed device. It is important, therefore, that the claims be regarded as including such equivalent construction and methodology insofar as they do not depart from the spirit and scope of the present invention. As used in the claims to describe the various inventive aspects and embodiments, “comprising” means including, but not limited to, whatever follows the word “comprising”. Thus, use of the term “comprising” indicates that the listed elements are required or mandatory, but that other elements are optional and may or may not be present. By “consisting of” is meant including, and limited to, whatever follows the phrase “consisting of”. Thus, the phrase “consisting of” indicates that the listed elements are required or mandatory, and that no other elements may be present. By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they affect the activity or action of the listed elements.

The objects features, and advantages of the present invention, as well as the advantages thereof over existing prior art, which will become apparent from the description to follow, are accomplished by the improvements described in this specification and hereinafter described in the following detailed description which fully discloses the invention, but should not be considered as placing limitations thereon.

### BRIEF DESCRIPTION OF THE FIGURES

The accompanying drawings, which are incorporated herein and form a part of the specification, illustrate some, but not the only or exclusive, examples of embodiments and/or features.

FIG. 1 shows a perspective view of an infected Arecacea tree.

FIG. 2 shows a perspective view of an infected Arecacea tree receiving fumigants.

FIG. 3 shows a perspective view of an infected Arecacea tree with foam bars.

FIG. 4 shows a perspective view of an infected Arecacea tree with plastic wrap.

FIG. 5 shows a perspective view of an infected Arecacea tree with strapping.

FIG. 6 shows a representative view of the invention method.

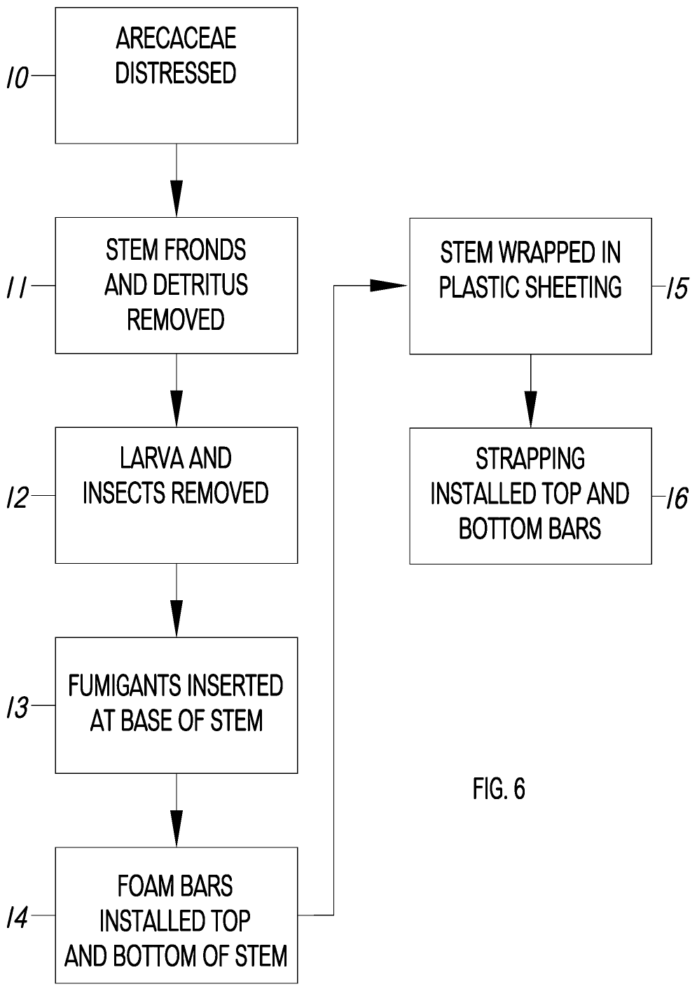

Other aspects of the present invention shall be more readily understood when considered in conjunction with the accompanying drawings, and the following detailed description, neither of which should be considered limiting.

### DETAILED DESCRIPTION OF FIGURES

In this description, the directional prepositions of up, upwardly, down, downwardly, front, back, top, upper, bottom, lower, left, right and other such terms refer to the device as it is oriented and appears in the drawings and are used for convenience only; they are not intended to be limiting or to imply that the device has to be used or positioned in any particular orientation.

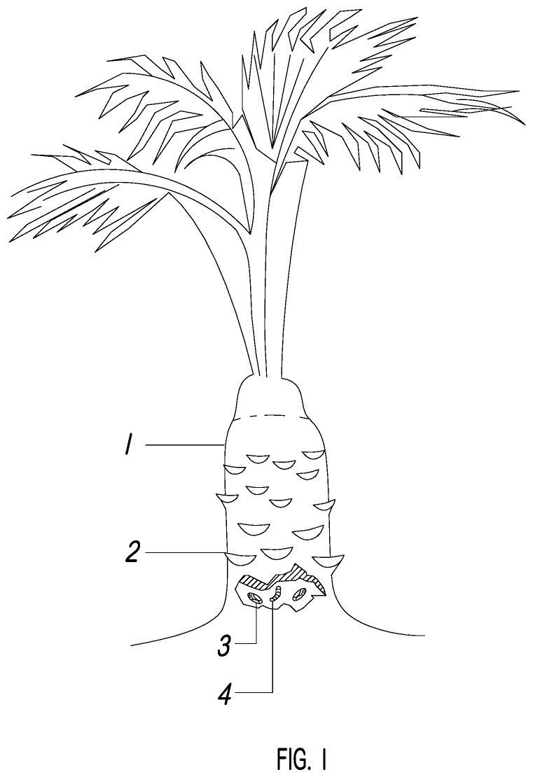

FIG. 1 shows a perspective view of an infected Arecacea tree with beetles 3 and larva 4 cohabitating inside said tree's stem 1. The figure showing the system of the tree being prepared by having fronds 2 removed and the available insects 3 and 4 being physically evacuated. In other embodiments, other types of palm trees may receive the system of this invention.

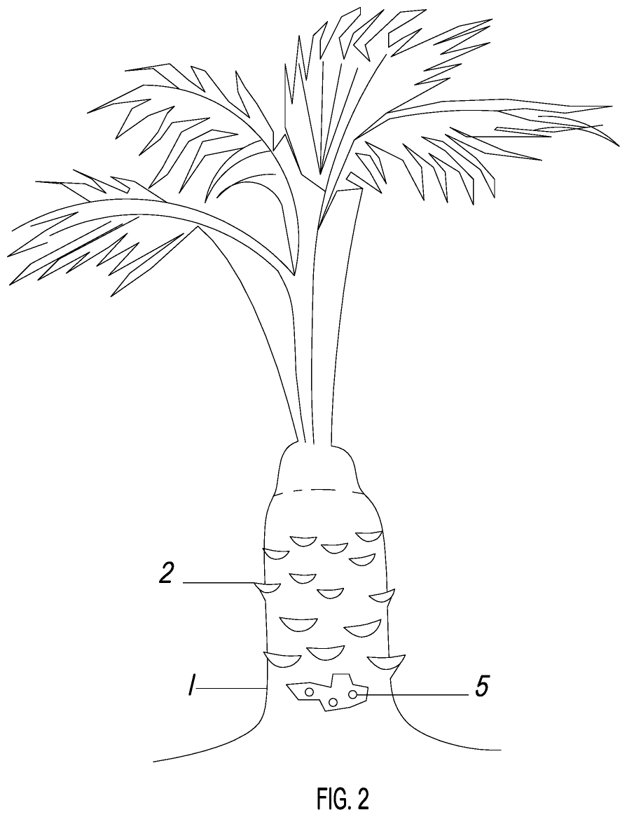

FIG. 2 shows a perspective view of an infected Arecacea tree stem 1 receiving fumigant tablets 5 such as, but not limited to, aluminum phosphide and the like.

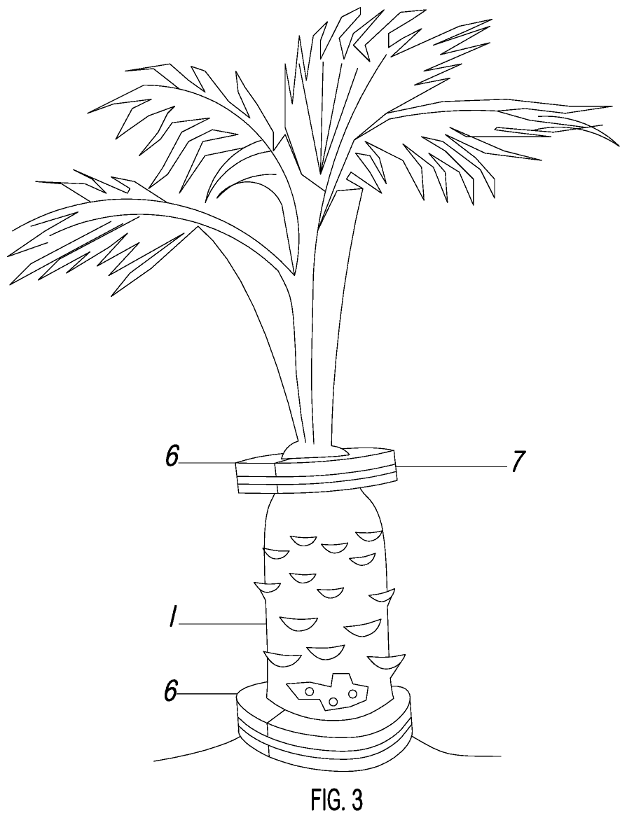

FIG. 3 shows a perspective view of an infected palm tree with foam bars 6. Said foam bars 6 being rectangular in shape and wrapped around said stem 1 radially and secured by, but not limited to adhesive strips 7, double-sided tape and the like thereon and being made of a flexible foam such as, but not limited to polyethylene, polyurethane and the like.

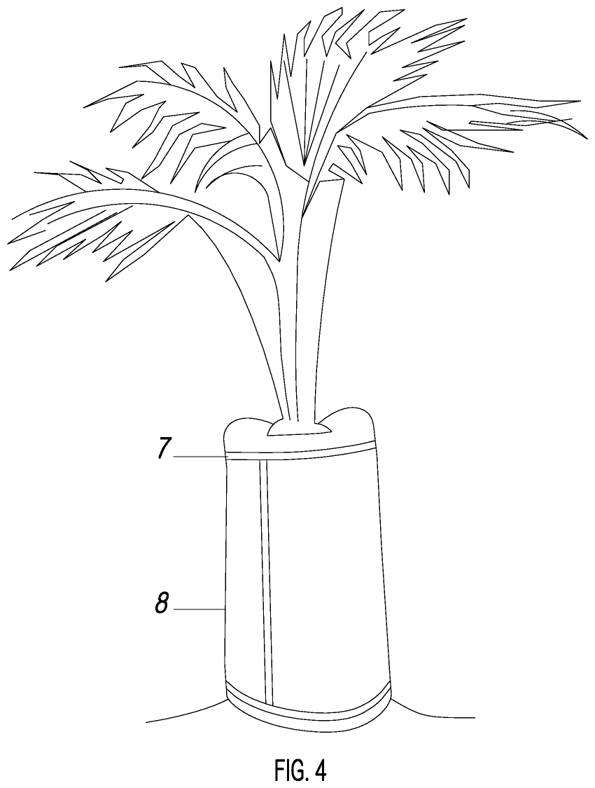

FIG. 4 shows a perspective view of an infected palm tree with plastic wrap 8 and being secured by tape 7. Said plastic wrap being made of a plastic sheeting such as, but not limited to, polyethylene, polyurethane terephthalate and the like.

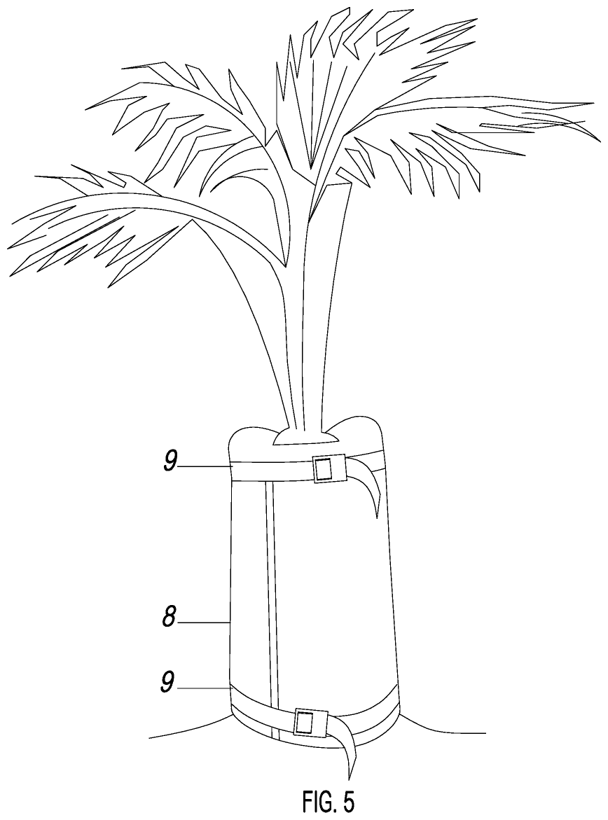

FIG. 5 shows a perspective view of an infected palm tree with strapping that when tightened creating a seal therein and being made of, but not limited to nylon webbing with rigid metal adjustment buckles there on.

FIG. 5 shows a representative view of the invention's method. When a palm tree is found distressed in step 10 the stem fronds and detritus at the base being removed in 11. Any available larva and beetles also being physically removed in step 12. Fumigant tablets being inserted at the base of said stem in step 13 and foam bars being wrapped and taped around the top and bottom of said stem in step 14. Plastic sheeting then being wrapped around and taped to foam bars in step 15 and finally, strapping being tightened over said sheeting and foam bars creating a seal and preventing fumigant gas from escaping therefrom in step 18.

It is additionally noted and anticipated that although the device is shown in its most simple form, various components and aspects of the device may be differently shaped or slightly modified when forming the invention herein. As such those skilled in the art will appreciate the descriptions and depictions set forth in this disclosure or merely meant to portray examples of preferred modes within the overall scope and intent of the invention, and are not to be considered limiting in any manner. While all of the fundamental characteristics and features of the invention have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art without departing from the spirit or scope of the invention.

What is claimed is:

1. A palm tree fumigant system comprised of the following parts:
(a) fumigant tablets;
(b) plastic sheeting;
(b) foam bars; and
(c) adjustable strapping.

2. The foam bars of claim 1 having adhesive strips thereon.

3. A method of eradicating insects in palm trees, the method comprised of the following:
(a) Fumigating palm trees;
(b) Sealing fumigants inside palm trees;
(c) Preventing human exposure to fumigants inside palm trees; and
(d) Securing the fumigant system to palm trees of different sizes.

4. The securing the fumigant system to palm trees of claim 3 using the adjustable strapping of claim 1.
